(19) United States
(12) Patent Application Publication
(10) Pub. No.: US 2025/0265550 A1
(43) Pub. Date: Aug. 21, 2025

(54) SCHEDULE-BASED INFORMATION PROCESSING METHOD AND APPARATUS

(71) Applicant: Beijing Zitiao Network Technology Co., Ltd., Haidian District, Beijing (CN)

(72) Inventors: Yu JIANG, Beijing (CN); Juan WANG, Beijing (CN)

(21) Appl. No.: 18/857,994

(22) PCT Filed: Apr. 14, 2023
(86) PCT No.: PCT/CN2023/088351

§ 371 Date: Oct. 18, 2024

(30) Foreign Application Priority Data
May 6, 2022 (CN) 202210486976.9

(51) Int. Cl. G06Q 10/1093; H04L 12/18

(52) U.S. Cl. CPC G06Q 10/1095; H04L 12/1822

(57) ABSTRACT

In a schedule-based information processing method, a client may receive an operation of displaying an associated interface of a target schedule triggered by a user, and when a schedule participating object includes a group object associated with the target schedule, the client may determine an operating permission of the user for the group object. Further, a display mode of the associated interface is determined based on the operating permission of the user for the group object, and after the display mode of the associated interface is determined, the associated interface is displayed based on the display mode.

### CROSS-REFERENCE TO RELATED APPLICATION(S)

This application claims priority to Chinese Patent Application No. 202210486976.9, filed with China National Intellectual Property Administration on May 6, 2022, and entitled “SCHEDULE-BASED INFORMATION PROCESSING METHOD AND APPARATUS”, which is incorporated herein by reference in its entirety.

### FIELD

This application relates to the technical field of computers, and in particular to a schedule-based information processing method and apparatus.

### BACKGROUND

Some applications can provide a schedule creation function to facilitate users to work according to the plan. By creating a schedule, other users can be invited to participate in the scheduling. The user corresponding to a schedule participating object can view information related to the schedule through an associated interface of the schedule.

How to optimize the content displayed on the associated interface of the schedule is a problem to be solved at present.

### SUMMARY

In order to solve the above technical problems or at least partially solve the above technical problems, this application provides a schedule-based information processing method and apparatus.

In a first aspect, an embodiment of this application provides a schedule-based information processing method. The method includes:
receiving an operation triggered by a user for displaying an associated interface of a target schedule;
determining, in response to a schedule participating object including a group object associated with the target schedule, an operating permission of the user for the group object;
determining, based on the operating permission, a display mode of the associated interface; and
displaying the associated interface based on the display mode.

Optionally, determining the operating permission of the user for the group object includes:
determining that the user has a permission to view an interface corresponding to the group object.

Optionally, determining the display mode of the associated interface based on the operating permission includes:
determining that the associated interface includes information about the group object and a first control in response to determining that the user has the permission to view the interface corresponding to the group object, the first control being used for triggering the display of the interface corresponding to the group object.

Optionally, the method further includes:
displaying an interface corresponding to the group object in response to an operation triggered by the user through the first control.

Optionally, the interface corresponding to the group object includes:
a group chat interface.

Optionally, the method further includes:
displaying a chat interface of a conference group associated with the target schedule in response to an operation triggered by the user through a second control in the associated interface, the conference group being created based on a conference group creation operation of a user with a conference group creation permission, and group members of the conference group include schedule participating objects of the target schedule.

Optionally, the receiving an operation triggered by a user to display an associated interface of a target schedule includes:
receiving a schedule viewing operation triggered by the user for the target schedule on the target interface.

Optionally,
the target interface is a calendar interface; or,
the target interface is a schedule reminder interface; or,
the target interface is an interface corresponding to a conference group associated with the target schedule; or,
the target interface is a schedule preview interface, the schedule preview interface including summary information of a plurality of schedules for the schedule participating object, and the plurality of schedules include the target schedule; or,
the target interface is an email interface.

Optionally, the schedule reminder interface may be displayed after the user triggers a preset operation for a schedule reminder message.

Optionally, the schedule preview interface is displayed after the user triggers a hover operation on the calendar interface.

Optionally, the associated interface of the target schedule is an editing interface of the target schedule.

Optionally, receiving the operation triggered by the user for displaying the associated interface of a target schedule includes:
receiving a preset operation triggered by the user for a target reminder message, where the target reminder message is a reminder message related to a multimedia conference associated with the target schedule.

In a second aspect, an embodiment of this application provides a schedule-based information processing apparatus. The apparatus includes:
a receiving unit, configured to receive an operation triggered by a user for displaying an associated interface of a target schedule;
a first determining unit, configured to determine, in response to a schedule participating object including a group object associated with the target schedule, an operating permission of the user for the group object;
a second determining unit, configured to determine a display mode of the associated interface based on the operating permission; and
a first display unit, configured to display the associated interface based on the display mode.

Optionally, the first determining unit is configured to:
determine that the user has a permission to view an interface corresponding to the group object.

Optionally, the determining a display mode of the associated interface based on the operating permission includes:
determining that the associated interface includes information about the group object and a first control in response to determining that the user has the permission to view the interface corresponding to the group object, where the first control is configured to trigger the display of the interface corresponding to the group object.

Optionally, the apparatus further includes:
a second display unit, configured to display an interface corresponding to the group object in response to the operation triggered by the user through the first control.

Optionally, the interface corresponding to the group object includes:
a group chat interface.

Optionally, the apparatus further includes:
a third display unit, configured to display a chat interface of a conference group associated with the target schedule in response to an operation triggered by the user through a second control in the associated interface, the conference group being created based on a conference group creation operation of a user with a conference group creation permission, and group members of the conference group including schedule participating objects of the target schedule.

Optionally, the receiving unit is configured to:
receive a schedule viewing operation triggered by the user for the target schedule on the target interface.

Optionally,
the target interface is a calendar interface; or,
the target interface is a schedule reminder interface; or,
the target interface is an interface corresponding to a conference group associated with the target schedule; or,
the target interface is a schedule preview interface, where the schedule preview interface includes summary information of a plurality of schedules for the schedule participating object, and the plurality of schedules include the target schedule; or,
the target interface is an email interface.

Optionally, the schedule reminder interface may be displayed after the user triggers a preset operation for a schedule reminder message.

Optionally, the schedule preview interface is displayed after the user triggers a hover operation on the calendar interface.

Optionally, the associated interface of the target schedule is an editing interface of the target schedule.

Optionally, the receiving unit is configured to:
receive a preset operation triggered by the user for a target reminder message, the target reminder message being a reminder message related to a multimedia conference associated with the target schedule.

In a third aspect, an embodiment of this application provides a device. The device includes a processor and a memory; and
the processor is configured to execute instructions stored in the memory to enable the device to perform the method according to any one of items in the first aspect.

In a fourth aspect, an embodiment of this application provides a computer-readable storage medium, including instructions. The instructions indicate a device to perform the method according to any one of items in the first aspect.

In a fifth aspect, an embodiment of this application provides a computer program product. The computer program product, when running on a computer, enables the computer to perform the method according to any one of items in the first aspect.

Compared with the prior art, the embodiments of this application have the following advantages:
this embodiment of this application provides the schedule-based information processing method, and in an example, the method may be performed by a client. The client may receive the operation triggered by the user to display the associated interface of the target schedule, and when the schedule participating objects include the group object associated with the target schedule, the client may determine the operating permission of the user for the group object. Further, the display mode of the associated interface is determined based on the operating permission of the user for the group object, and after determining the display mode of the associated interface, the associated interface is displayed based on the display mode. It can be seen that in the embodiments of this application, when the associated interface of the target schedule is displayed on the client, if the schedule participating objects corresponding to the users include the group object associated with the target schedule, the display mode of the associated interface is determined based on the operating permission of the user for the group object. Compared adopting the method with adopting the unified display mode to display the associated interface of the target schedule to the users corresponding to the schedule participating objects, the display mode of the associated interface of the target schedule that is displayed by adopting the solution matches the operating permission of the user for the group object, thereby making the displayed associated interface better meet user needs.

### BRIEF DESCRIPTION OF THE DRAWINGS

In order to describe technical solutions in the embodiments of this application or in the prior art more clearly, the accompanying drawings required to be used in the descriptions of the embodiments or the prior art will be briefly introduced below, it is apparent that the accompanying drawings described below are only some embodiments recorded in this application, and those of ordinary skill in the art can obtain other accompanying drawings according to these accompanying drawings without creative work.

FIG. 1 is a schematic flowchart of a schedule-based information processing method according to an embodiment of this application;

FIG. 2 is a structural schematic diagram of an associated interface according to an embodiment of this application; and

FIG. 3 is a structural schematic diagram of a schedule-based information processing apparatus according to an embodiment of this application.

### DETAILED DESCRIPTION OF EMBODIMENTS

In order to make those skilled in the art better understand the solutions of this application, the technical solutions in the embodiments of this application are clearly and completely described in conjunction with the accompanying drawings in the embodiments of this application as below, and it is apparent that the described embodiments are merely a part rather all embodiments of this application. All other embodiments obtained by those of ordinary skill in the art based on the embodiments of this application without creative efforts shall fall within the scope of protection of this application.

The inventors of this application found through research that users corresponding to schedule participating objects can view information related to a schedule through an associated interface of the schedule. Currently, a unified display mode is adopted to show the associated interface of the target schedule to the users corresponding to the schedule participating objects. However, the display mode often fails to meet user needs. Specifically, for a schedule, the schedule may be associated with a corresponding group object, and the group object may include some or all of the schedule participating objects. If the schedule participating objects include the group object associated with the schedule, the schedule participating objects may want to obtain relevant information about the group object from the associated interface of the schedule, or may want to trigger operations related to the group object on the associated interface of the schedule. Correspondingly, if the schedule participating objects do not include the group object associated with the schedule, the schedule participating objects have no need to trigger operations related to the group object on the associated interface of the schedule.

In order to solve the above problems, embodiments of this application provide a schedule-based information processing method and apparatus.

Various non-limiting implementations of this application are described in detail in conjunction with the accompanying drawings below.

### Exemplary Method

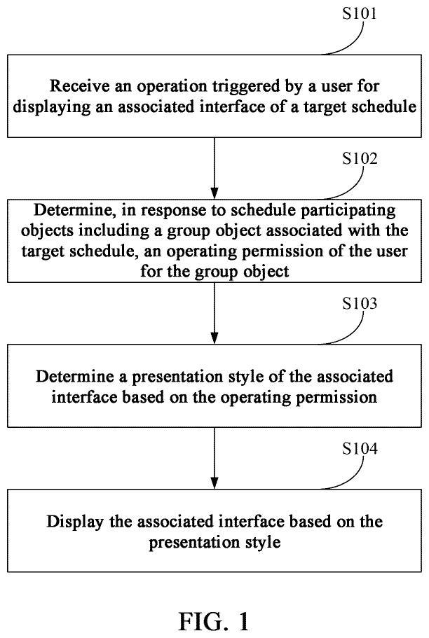

Referring to FIG. 1, FIG. 1 is a schematic flowchart of a schedule-based information processing method according to an embodiment of this application. The method shown in FIG. 1 may be, for example, performed by a client.

Regarding the client mentioned here, it should be noted that a target schedule may include a plurality of schedule participating objects, and the client mentioned here may be a client corresponding to any one of the plurality of schedule participating objects. The user mentioned below may be a user who performs corresponding operations on the client. For example, the user mentioned in S101 may be a user who performs corresponding operations on the client corresponding to the “schedule participating object” mentioned in S102.

In this embodiment, for example, the method may include the following steps S101 to S104.

S101: an operation triggered by a user to display an associated interface of a target schedule is received.

The associated interface of the target schedule is used for displaying information related to the target schedule. This embodiment of this application does not specifically limit the information to be related to the target schedule. The related information of the target schedule may include a name of the target schedule, time of the target schedule, participants of the target schedule, etc., which are not enumerated here.

Regarding the associated interface, it should be noted that:
in an example, the associated interface may be an editing interface of the target schedule. When the target schedule has an associated group object, the editing interface may include information related to the group object associated with the schedule.

In another example, the user may trigger the operation of the display of the associated interface of the target schedule on the client. Correspondingly, after receiving the operation of the user in triggering the display of the associated interface of the target schedule, the associated interface may be further displayed.

This embodiment of this application does not specifically limit the operation of the user in triggering the display of the associated interface of the target schedule.

In an example, the target schedule may have an associated multimedia conference, such as a video conference. Accordingly, the client may display a target reminder message related to the multimedia conference, such as “Multimedia conference is about to start” or “Multimedia conference is in progress”. In this case, the user may trigger a preset operation in response to the target reminder message, such as clicking on the target reminder message. Correspondingly, after receiving the preset operation triggered by the user in response to the target reminder message, the client may display the associated interface of the target schedule. In this case, the operation triggered by the user to display the associated interface of the target schedule may be the preset operation triggered by the user for the target reminder message.

In another example, the user may trigger a schedule viewing operation for the target schedule on the target interface. After the user triggers the schedule viewing operation for the target schedule, the client displays the associated interface of the target schedule. In this case, the above operation triggered by the user for displaying the associated interface of the target schedule may be the schedule viewing operation triggered by the user on the target schedule from the target interface.

The target interface may be an interface related to the target schedule. Next, several possible cases of the target interface are explained.

In an example, considering that the schedule interface of the above schedule participating object may include summary information of schedules related to the schedule participating object, the user may trigger the operation to view the corresponding schedule based on the summary information of any one of the schedules. For example, the user may trigger the operation to view the target schedule based on the summary information of the target schedule. Therefore, as an example, the target interface may be a calendar interface. Regarding the summary information of the schedule, it should be noted that the summary information of the schedule may be partial information of the schedule. The summary information of the schedule, for example, may include a name of the schedule, occurrence time of the schedule, etc., which are not enumerated here.

In another example, considering that a schedule reminder interface of the above schedule participating object may include summary information of schedules related to the schedule participating object, the user may trigger the operation to view the corresponding schedule based on the summary information of any one of the schedules. For example, the user may trigger the operation to view the target schedule based on the summary information of the target schedule. Therefore, as an example, the target interface may be the schedule reminder interface.

In some embodiments, the schedule reminder interface may be an instant messaging chat interface. For example, the instant messaging chat interface may be an instant messaging chat interface corresponding to “Schedule Assistant” or “Calendar Assistant”. The “Schedule Assistant” or “Calendar Assistant” may send a schedule reminder message for the target schedule to the schedule participating object before the target schedule starts.

In some other embodiments, the schedule reminder interface may be displayed after the user triggers the preset operation for the schedule reminder message. As an example, a homeinterface of the client displays the schedule reminder message for the target schedule. After the user triggers the preset operation (e.g., the user clicks on the schedule reminder message) for the schedule reminder message, the client further displays the corresponding schedule reminder interface. The schedule reminder message mentioned here may be used for indicating a current status of a certain schedule (e.g., the target schedule) related to the schedule participating object, such as indicating that the target schedule is about to start or is currently in progress.

In another example, considering that the target schedule may have a corresponding conference group, the user may trigger the schedule viewing operation for the target schedule on an interface corresponding to the conference group. Therefore, as an example, the target interface may a the interface corresponding to the conference group associated with the target schedule. Regarding the conference group, it should be noted that members of the conference group include all participants in the target schedule.

In another example, the schedule participating object may be associated with a plurality of schedules, and the plurality of schedules include the target schedule. The user may view summary information of the plurality of schedules associated with the schedule participating object through a schedule preview interface of the schedule participating object. That is, the schedule preview interface may include the summary information of the plurality of schedules for the schedule participating object. In this case, the user may also trigger the schedule viewing operation for the target schedule based on the summary information of the target schedule on the schedule preview interface. Therefore, as an example, the target interface may be the schedule preview interface. In an example, the user may trigger a hover operation for the calendar interface displayed by the client, and correspondingly, the client may display the schedule preview interface in response to the hover operation.

In another example, considering that in some scenarios, email content received or sent by the schedule associated object includes relevant information about the target schedule, therefore, in an example, the target interface may be an email interface.

After receiving the operation triggered by the user to display the associated interface of the target schedule, the client may further display of the associated interface of the target schedule. In this embodiment of this application, the client may first determine the display mode of the associated interface and then display the associated interface based on the display mode.

Determining the display mode of the associated interface may be implemented through S102 and S103 as below.

S102: in response to schedule participating objects including a group object associated with the target schedule, an operating permission of the user for the group object is determined.

The client may first determine whether the schedule participating objects include a group object associated with the target schedule. After the client determines that the schedule participating objects have the group object associated with the target schedule, the operating permission of the user for the group object may be determined. The operating permission of the user for the group object mentioned here includes, but is not limited to, the permission of viewing information related to the group object.

Regarding the group object associated with the target schedule, it should be noted that users in the group object are treated as a whole to be associated with the target schedule. In an example, when the target schedule is created, the corresponding group object may be associated with the target schedule. After the group object is associated with the target schedule, all users in the group object are associated with the target schedule.

In an example, the operating permission of the user for the group object may be the permission for the user to view an interface corresponding to the group object. The interface corresponding to the group object mentioned here may be an interface used for displaying information related to the group object, or an interface for information exchange among members of the group object. The embodiments of this application do not impose specific limitations. In an example, the interface corresponding to the group object may be a group chat interface. The group chat interface may be, for example, an instant messaging group chat interface. In this case, users corresponding to the schedule participating objects having the group object have the permission to view the group chat interface corresponding to the group object.

S103: a display mode of the associated interface is determined based on the operating permission.

After the operating permission of the user for the group object is determined, the display mode that matches the operating permission may be determined based on the operating permission.

In an example, when the user has the permission to view the interface corresponding to the group object, the determined display mode matches the permission of the user in viewing the interface corresponding to the group object. As an example, the determined display mode may be that the associated interface includes information about the group object and a first control. The information about the group object may include, for example, a name of the group object and an icon of the group object. The first control is configured to trigger the display of the interface corresponding to the group object. In this case, in an example:
if the user has the permission to view the interface corresponding to the group object, the first control configured to trigger the display of the interface corresponding to the group object is displayed on the associated interface, such that the user can trigger, based on the first control, the operation of displaying the interface corresponding to the group object. In this case, when the user wants to view the interface corresponding to the group object, there is no need for the user to first determine the group object associated with the target schedule from many group objects, and then trigger the operation of displaying the interface corresponding to the group object associated with the target schedule. The user may directly determine, through the associated interface of the target schedule, the group object associated with the target schedule, and may directly trigger, through the first control displayed on the associated interface of the target schedule, the operation of displaying the interface corresponding to the group object associated with the target schedule, and therefore the user can perform the operation conveniently.

As mentioned earlier, the interface corresponding to the group object may be the instant messaging group chat interface. Therefore, the first control is a control for the user to trigger the display of the instant messaging group chat interface. In an example, the first control may, for example, correspond to an icon on the associated interface.

S104: the associated interface is displayed based on the display mode.

After determining the display mode, the client may display the associated interface based on the display mode. For example, as mentioned above, when the display mode indicates that the associated interface includes the information about the group object and the first control, the displayed associated interface includes the information about the group object and the first control.

In an example, after displaying the associated interface that includes the first control, the user may trigger the operation (e.g., clicking on the icon of the corresponding first control on the associated interface) through the first control. Correspondingly, the client may display the interface corresponding to the group object in response to the operation triggered by the user through the first control. It can be seen from the above description that in the embodiments of this application, when the associated interface of the target schedule is displayed on the client, if the schedule participating objects corresponding to the users include the group object associated with the target schedule, the display mode of the associated interface is determined based on the operating permission of the user for the group object. Compared adopting the method with adopting the unified display mode to display the associated interface of the target schedule to the users corresponding to the schedule participating objects, the display mode of the associated interface of the target schedule that is displayed by adopting the solution matches the operating permission of the user for the group object, thereby making the displayed associated interface better meet user needs. For example, when the user has the permission to view the interface corresponding to the group object, the associated interface displays the information about the associated object and the first control configured to trigger the display of the instant messaging chat interface corresponding to the group object. After the user triggers the operation through the first control, the client displays the instant messaging chat interface corresponding to the group object, and therefore the user can perform the operation conveniently.

In an example, the target schedule may have an associated conference group. In this case, the associated interface may also include a second control. The second control is configured to trigger the display of a chat interface of the conference group. In this case, the user may also trigger a corresponding operation through the second control. Correspondingly, the client may display the chat interface of the conference group associated with the target schedule in response to the operation triggered by the user for the second control.

Regarding the conference group, it should be noted that the conference group may be created by the user with a conference group creation permission, where the user with the conference group creation permission may create a conference group by triggering a conference group creation operation. A method for creating conference groups is not described in detail here.

In addition, the conference group is distinguished from the above group object. The group object may include some or all of the schedule participating objects of the target schedule, while members of the conference group include all schedule participating objects of the target schedule.

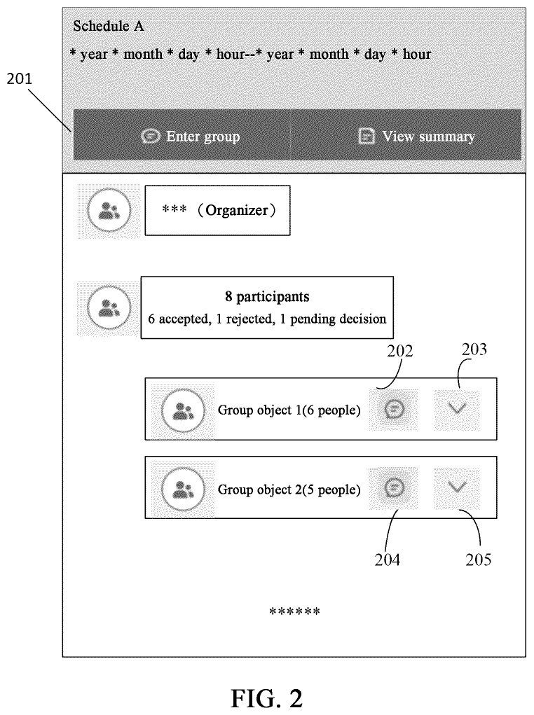

The schedule-based information processing method provided in the embodiments of this application is described in conjunction with FIG. 2.

FIG. 2 is a structural schematic diagram of an associated interface according to an embodiment of this application.

The associated interface shown in FIG. 2 is an associated interface for a target schedule (schedule A). The associated interface shown in FIG. 2 displays a name of the schedule A, time of the schedule A, an organizer of the schedule A, the number of participants in the schedule A, whether the participants agree to join the schedule A, and group objects associated with the schedule A. where the group objects include a group object 1 and a group object 2, and in addition, the schedule A also has an associated conference group.

As shown in FIG. 2, the associated interface includes a control 201. The control 201 may correspond to the second control mentioned in the above embodiment. When the user clicks on the control 201, the client may display a chat interface of the conference group associated with the target schedule.

The associated interface further includes a control 202 associated with the group object 1. The control 202 may correspond to the first control in the above embodiment. When the user clicks on the control 202, the client may display an interface corresponding to the group object 1 associated with the target schedule, such as a group chat interface corresponding to the group object 1. In addition, the associated interface further includes a control 203 associated with the group object 1. After the user clicks on the control 203, the associated interface may display information about group members of the group object 1, such as displaying user names and avatars of the group members.

In an example, after the user triggers the hover operation on the control 202, the client may display a corresponding function of the control 202 on the associated interface. For example, the client may display “Enter group chat interface”.

In an example, after the user triggers the hover operation on the control 203, the client may display a corresponding function of the control 203 on the associated interface. For example, the client may display “Expand group members”.

In an example, the associated interface further includes information related to the group object 2, but the user is not a member of the group object 2. In this case, in an example, the associated interface includes information about the group object 2, but does not include the first control associated with the group object 2.

In another example, as shown in FIG. 2, the associated interface includes a control 204 and a control 205, where the control 204 is the first control corresponding to the group object 2. In this case, in some embodiments, the control 204 and the control 205 cannot be operated. For example, after the user triggers the operation on the control 204 or the control 205, the client does not respond. In some other embodiments, after the user triggers the operation on the control 204 or the control 205, the client displays an interface to apply for joining the group object. Other contents in the associated interface are not described in detail here.

### Exemplary Device

Based on the method provided in the above embodiments, an embodiment of this application further provides an apparatus. The apparatus is introduced in conjunction with the accompanying drawings below.

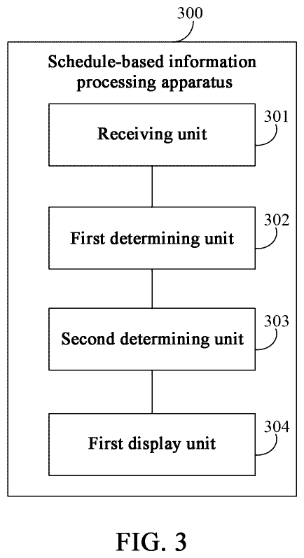

Referring to FIG. 3, FIG. 3 is a structural schematic diagram of a schedule-based information processing apparatus according to an embodiment of this application. The apparatus 300 may specifically include, for example, a receiving unit 301, a first determining unit 302, a second determining unit 303, and a first display unit 304.

The receiving unit 301 is configured to receive an operation triggered by a user to display an associated interface of a target schedule;
the first determining unit 302 is configured to determine, in response to schedule participating objects including a group object associated with the target schedule, an operating permission of the user for the group object;
the second determining unit 303 is configured to determine a display mode of the associated interface based on the operating permission; and
the first display unit 304 is configured to display the associated interface based on the display mode.

Optionally, the first determining unit 302 is configured to:
determine that the user has a permission to view an interface corresponding to the group object.

Optionally, the step of determining a display mode of the associated interface based on the operating permission includes:
it is determined that the associated interface includes information about the group object and a first control in response to determining that the user has the permission to view the interface corresponding to the group object, where the first control is configured to trigger the display of the interface corresponding to the group object.

Optionally, the apparatus further includes:
a second display unit, configured to display an interface corresponding to the group object in response to the operation triggered by the user through the first control.

Optionally, the interface corresponding to the group object includes:
a group chat interface.

Optionally, the apparatus further includes:
a third display unit, configured to display a chat interface of a conference group associated with the target schedule in response to an operation triggered by the user through a second control on the associated interface, where the conference group is created by the user with a conference group creation permission based on a conference group creation operation, and group members of the conference group include schedule participating objects of the target schedule.

Optionally, the receiving unit 301 is configured to:
receive a schedule viewing operation triggered by the user for the target schedule on the target interface.

Optionally,
the target interface is a calendar interface; or,
the target interface is a schedule reminder interface; or,
the target interface is an interface corresponding to a conference group associated with the target schedule; or,
the target interface is a schedule preview interface, where the schedule preview interface includes summary information of a plurality of schedules for the schedule participating object, and the plurality of schedules include the target schedule; or,
the target interface is an email interface.

Optionally, the schedule reminder interface may be displayed after the user triggers a preset operation for a schedule reminder message.

Optionally, the schedule preview interface is displayed after the user triggers a hover operation on the calendar interface.

Optionally, the associated interface of the target schedule is an editing interface of the target schedule.

Optionally, the receiving unit 301 is configured to:
receive a preset operation triggered by the user for a target reminder message, where the target reminder message is a reminder message related to a multimedia conference associated with the target schedule.

Because the apparatus 300 is an apparatus corresponding to the method provided in the above method embodiments, and specific implementations of various units of the apparatus 300 and the above method embodiments belong to the same concept, for the specific implementations of the various units of the apparatus 300, reference may be made to a description section of the above method embodiments, which will not be repeated here.

An embodiment of this application further provides a device. The device includes a processor and a memory.

The processor is configured to execute instructions stored in the memory, such that the device performs the schedule-based information processing method according to any one of the above method embodiments.

An embodiment of this application further provides a computer-readable storage medium including instructions. The instructions indicate a device to perform the schedule-based information processing method according to any one of the above method embodiments.

An embodiment of this application provides a computer program product. The computer program product, when running on a computer, enables the computer to perform the schedule-based information processing method according to any one of the above method embodiments.

Other implementation solutions of this application can be easily conceived by those skilled in the art after considering the specification and the practice of the present invention disclosed herein. This application is intended to cover any variation, usage, or adaptive change of this application, which follows the general principles of this application and includes common general knowledge or customary technical means in the art that are not disclosed in the present disclosure. The specification and embodiments are merely to be considered as illustrative, while the true scope and spirit of this application are indicated by the claims below.

It should be understood that this application is not limited to the precise structures described above and shown in the accompanying drawings, and various modifications and changes may be made without departing from the scope thereof. The scope of this application is merely limited by the appended claims.

The foregoing descriptions are merely preferred embodiments of this application, but are not intended to limit this application. Any modification, equivalent replacement, improvement, etc. made within the spirit and principle of this application shall fall within the scope of protection of this application.

1. A schedule-based information processing method, comprising:
receiving an operation triggered by a user for displaying an associated interface of a target schedule;
determining, in response to a schedule participating object comprising a group object associated with the target schedule, an operating permission of the user for the group object;
determining, based on the operating permission, a display mode of the associated interface; and
displaying the associated interface based on the display mode.

2. The method according to claim 1, wherein determining the operating permission of the user for the group object comprises:
determining the user permission to view an interface corresponding to the group object.

3. The method according to claim 2, wherein determining the display mode of the associated interface based on the operating permission comprises:
determining that the associated interface comprises information about the group object and a first control, in response to determining that the user has the permission to view the interface corresponding to the group object, the first control being used for triggering the display of the interface corresponding to the group object.

4. The method according to claim 3, further comprising:
displaying an interface corresponding to the group object in response to an operation triggered by the user through the first control.

5. The method according to claim 2, wherein an interface corresponding to the group object comprises:
a group chat interface.

6. The method according to claim 1, further comprising:
displaying a chat interface of a conference group associated with the target schedule in response to an operation triggered by the user through a second control in the associated interface, the conference group being created based on a conference group creation operation of a user with a conference group creation permission, and group members of the conference group comprising schedule participating objects of the target schedule.

7. The method according to claim 1, wherein receiving the operation of displaying the associated interface of the target schedule triggered by the user comprises:
receiving a schedule viewing operation triggered by the user for the target schedule on the target interface.

8. The method according to claim 7, wherein
the target interface is a calendar interface; or,
the target interface is a schedule reminder interface; or,
the target interface is an interface corresponding to a conference group associated with the target schedule; or,
the target interface is a schedule preview interface, the schedule preview interface comprising summary information of a plurality of schedules for the schedule participating object, and the plurality of schedules comprising the target schedule; or,
the target interface is an email interface.

9. The method according to claim 8, wherein the schedule reminder interface is displayed after the user triggers a preset operation for a schedule reminder message.

10. The method according to claim 8, wherein the schedule preview interface is displayed after the user triggers a hover operation on the calendar interface.

11. The method according to claim 1, wherein an associated interface of the target schedule is an editing interface of the target schedule.

12. The method according to claim 1, wherein receiving the operation of displaying the associated interface of the target schedule triggered by the user comprises:
receiving a preset operation triggered by the user for a target reminder message, wherein the target reminder message is a reminder message related to a multimedia conference associated with the target schedule.

13. (canceled)

14. A device, comprising a processor and a memory, wherein
the processor is used for executing instructions stored in the memory to cause the device to:
receive an operation triggered by a user for displaying an associated interface of a target schedule;
determine, in response to a schedule participating object comprising a group object associated with the target schedule, an operating permission of the user for the group object;
determine, based on the operating permission, a display mode of the associated interface; and
display the associated interface based on the display mode.

15. (canceled)

16. A computer program product, stored on a non-transitory computer-readable storage medium, wherein the computer program product, when executed on a computer, causes the computer to:
receive an operation triggered by a user for displaying an associated interface of a target schedule;
determine, in response to a schedule participating object comprising a group object associated with the target schedule, an operating permission of the user for the group object;
determine, based on the operating permission, a display mode of the associated interface; and
display the associated interface based on the display mode.

17. The device according to claim 14, wherein the processor, that causes the device to determine the operating permission of the user for the group object, further the device to:
determine that the user has permission to view an interface corresponding to the group object.

18. The device according to claim 17, wherein the processor, that causes the computer to determine the display mode of the associated interface based on the operating permission, further causes the device to:
determine that the associated interface comprises information about the group object and a first control in response to determining that the user has the permission to view the interface corresponding to the group object, the first control being used for triggering the display of the interface corresponding to the group object.

19. The device according to claim 17, wherein the processor further causes the device to:
display an interface corresponding to the group object in response to an operation triggered by the user through the first control.

20. The device according to claim 17, wherein an interface corresponding to the group object comprises:
a group chat interface.

21. The device according to claim 16, wherein the processor further causes the device to:
display a chat interface of a conference group associated with the target schedule in response to an operation triggered by the user through a second control in the associated interface, the conference group being created based on a conference group creation operation of a user with a conference group creation permission, and group members of the conference group comprising schedule participating objects of the target schedule.

22. The device according to claim 16, wherein the processor, that causes the computer to receive the operation of displaying the associated interface of the target schedule triggered by the user, further causes the device to:
receiving a schedule viewing operation triggered by the user for the target schedule on the target interface.
